(19) United States
(12) Patent Application Publication
(10) Pub. No.: US 2022/0082666 A1
(43) Pub. Date: Mar. 17, 2022

(54) LASER SENSOR, POSTURE RECOGNITION SYSTEM, AND MIRROR CONTROL METHOD

(71) Applicant: FUJITSU LIMITED, Kawasaki-shi (JP)

(72) Inventors: KOSUKE YANAI, Kawasaki (JP); Yoshikatsu KOHARA, Kitakyushu (JP); Shinichi Fujiyoshi, Fukuoka (JP); Koichi Iida, Kobe (JP); Takeshi MORIKAWA, Yokohama (JP); Katsushi Sakai, Zama (JP)

(73) Assignee: FUJITSU LIMITED, Kawasaki-shi (JP)

(21) Appl. No.: 17/464,822

(22) Filed: Sep. 2, 2021

(30) Foreign Application Priority Data
Sep. 15, 2020 (JP) 2020-154396

(51) Int. Cl. G01S 7/481; G01S 17/46; G02B 26/08; G02B 26/10

(52) U.S. Cl. CPC G01S 7/4817; G02B 26/101; G02B 26/0833; G01S 17/46

(57) ABSTRACT

A laser sensor includes: a micro electro mechanical systems (MEMS) mirror that performs scanning in a reflection direction of laser light of a light emitting device on a first axis in a resonance direction and a second axis in a non-resonant direction; and a processor that performs control that synchronizes a drive cycle of the second axis with the drive cycle of the second axis of the MEMS mirror mounted on another laser sensor, using a timing designated based on the drive cycle of the first axis.

### CROSS-REFERENCE TO RELATED APPLICATION

This application is based upon and claims the benefit of priority of the prior Japanese Patent Application No. 2020-154396, filed on Sep. 15, 2020, the entire contents of which are incorporated herein by reference.

### FIELD

The embodiments discussed herein are related to a laser sensor, a posture recognition system, and a mirror control method.

### BACKGROUND

A technique that synchronizes a plurality of laser sensors provided with light emitting elements, micro electro mechanical systems (MEMS) mirrors, and light receiving elements is disclosed. The MEMS mirror is disclosed.

Japanese Laid-open Patent Publication No. 2018-63228 and Japanese Laid-open Patent Publication No. 2004-177957 are disclosed as related art.

### SUMMARY

According to an aspect of the embodiments, a laser sensor includes: a micro electro mechanical systems (MEMS) mirror that performs scanning in a reflection direction of laser light of a light emitting device on a first axis in a resonance direction and a second axis in a non-resonant direction; and a processor that performs control that synchronizes a drive cycle of the second axis with the drive cycle of the second axis of the MEMS mirror mounted on another laser sensor, using a timing designated based on the drive cycle of the first axis.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an overall configuration of a measurement system according to an embodiment;

FIG. 2 is an explanatory diagram of a time-of-flight (TOF) technology;

FIG. 3A is a diagram illustrating a slave frame pulse; FIG. 3B is a diagram illustrating a slave line pulse; FIG. 3C is a diagram illustrating a vertical drive signal generated according to the timing of a frame pulse; and FIG. 3D is a diagram illustrating a horizontal drive signal generated according to the timing of a line pulse;

FIG. 4 is a diagram illustrating a relationship between an ineffective pixel area and an effective pixel area during one round trip in a vertical direction;

FIG. 5 is a block diagram illustrating details of a synchronization control unit;

FIG. 6 is a flowchart representing an example of the operation of a posture recognition system;

FIG. 7 is a flowchart representing an example of synchronization control in step S23;

FIG. 8 is a diagram representing fluctuations in a counter value when the synchronization control in FIG. 7 is repeated;

FIG. 9 is a diagram illustrating details of steps S32 to S35;

FIG. 10 is a diagram illustrating details of step S32>step S33>step S36>step S35;

FIG. 11 is a diagram illustrating details of step S32>step S37>step S38>step S35;

FIG. 12 is a diagram illustrating details of step S32>step S37>step S39>step S35;

FIGS. 13A and 13B are diagrams illustrating drive cycles of a reference device;

FIGS. 14A to 14D are diagrams illustrating drive cycles of an adjustment target device;

FIG. 15 is a diagram for explaining the horizontal drive signal when being subject to synchronization control;

FIG. 16 is a diagram illustrating an application example of the measurement system; and

FIG. 17 is a diagram illustrating a hardware configuration.

### DESCRIPTION OF EMBODIMENTS

The MEMS mirror performs scanning using a first axis in a resonance direction and a second axis in a non-resonant direction. The resonance frequency sometimes varies from individual MEMS mirror to individual MEMS mirror. There is a possibility of damaging the MEMS mirrors when attempting to synchronize a plurality of MEMS mirrors with large resonance frequency differences.

In one aspect, a laser sensor, a mirror control method, and a posture recognition system capable of synchronizing MEMS mirrors may be provided.

Hereinafter, embodiments will be described with reference to the drawings.

### Embodiments

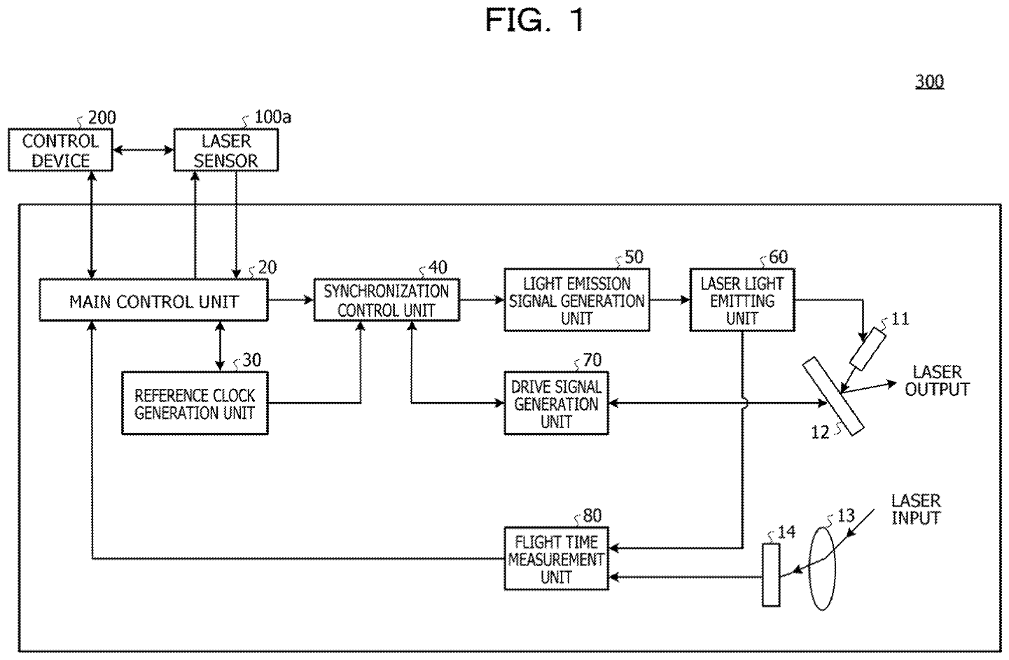

FIG. 1 is a schematic diagram illustrating an overall configuration of a posture recognition system 300 according to an embodiment. As illustrated in FIG. 1, the posture recognition system 300 includes a plurality of laser sensors 100a and 100b, a control device 200, and the like. The plurality of laser sensors 100a and 100b and the control device 200 are connected through a network by wire or wirelessly.

In the present embodiment, it is assumed that the laser sensor 100a functions as a master and the laser sensor 100b functions as a slave. For example, the laser sensor 100a is assumed as a device that is a reference for synchronization control (hereinafter, referred to as a reference device), and the laser sensor 100b is assumed as a device that is a target of synchronization control (hereinafter, referred to as an adjustment target device).

The laser sensor 100b includes a light emitting device 11, a MEMS mirror 12, a light receiving lens 13, a light receiving element 14, a main control unit 20, a reference clock generation unit 30, a synchronization control unit 40, a light emission signal generation unit 50, a laser light emitting unit 60, a drive signal generation unit 70, a flight time measurement unit 80, and the like. The laser sensor 100a also has a configuration similar to the configuration of the laser sensor 100b.

The light emitting device 11 is a device that emits laser light in accordance with an instruction from the laser light emitting unit 60, and includes a light emitting element such as a semiconductor laser. As an example, the light emitting device 11 emits pulsed light in a predetermined sampling cycle. The light emission signal generation unit 50 controls the laser light emitting unit 60. A timing at which the laser light emitting unit 60 instructs the light emitting device 11 to emit pulsed light is sent to the flight time measurement unit 80 from the light emission signal generation unit 50. This means that the flight time measurement unit 80 acquires the pulsed light emission timing.

The MEMS mirror 12 is a micro electro mechanical systems mirror, and is a mirror that changes the angle of emitted laser light three-dimensionally. The MEMS mirror 12 is a two-axis rotation type mirror, in which the angle of emitted laser light changes three-dimensionally, for example, in response to changes made in the rotation angle of a horizontal axis and the rotation angle of a vertical axis. The rotation angle of the horizontal axis is referred to as a horizontal angle H, and the rotation angle of the vertical axis is referred to as a vertical angle V. The drive signal generation unit 70 gives instructions on the horizontal angle H and the vertical angle V of the MEMS mirror 12. Pulsed light emitted from the light emitting device 11 is deflected according to the horizontal angle H and the vertical angle V of the MEMS mirror 12.

Pulsed light reflected by the MEMS mirror 12 is applied to a distance measurement target, scattered (reflected), and returned to the light receiving lens 13. This return light is collected by the light receiving lens 13 and received by the light receiving element 14.

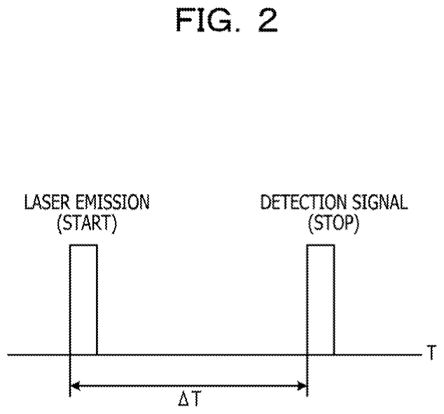

The flight time measurement unit 80 measures the distance to the distance measurement target by adopting a time-of-flight (TOF) technology. FIG. 2 is an explanatory diagram of the TOF technology. As illustrated in FIG. 2, the flight time measurement unit 80 measures a round-trip time (ΔT) from when the light emitting device 11 emits a laser pulse to when the return light returns from the distance measurement target, and calculates the distance to the distance measurement target by multiplying the measured round-trip time by the speed of light. Since the flight time measurement unit 80 is allowed to measure the distance every time the light emitting device 11 emits pulsed light, the distance may be measured in the sampling cycle.

The control device 200 transmits the frequency of a reference clock signal that defines the operation timing of the laser sensors 100a and 100b, to the laser sensors 100a and 100b. The frequency transmitted from the control device 200 is received by the main control unit 20.

The laser sensor 100a sends a frame pulse (master frame pulse) and a line pulse (master line pulse) of the laser sensor 100a to the inside and the outside of the laser sensor 100a. Details of the frame pulse and the line pulse will be described later.

The main control unit 20 sends the frequency received from the control device 200 to the reference clock generation unit 30. The reference clock generation unit 30 generates a reference clock signal at the received frequency. The reference clock signal generated by the reference clock generation unit 30 is sent to the main control unit 20 and the synchronization control unit 40. Furthermore, the main control unit 20 sends the master frame pulse and an adjustment threshold value to the synchronization control unit 40. In addition, the main control unit 20 generates a frame pulse (slave frame pulse) and a line pulse (slave line pulse) using the reference clock signal to send the generated slave frame pulse and slave line pulse to the drive signal generation unit 70 and also to send the slave frame pulse to the synchronization control unit 40.

The synchronization control unit 40 adjusts the received slave frame pulse according to the received master frame pulse and adjustment threshold value, and sends the adjusted slave frame pulse to the light emission signal generation unit 50 and the drive signal generation unit 70. The operation timings of the light emission signal generation unit 50 and the drive signal generation unit 70 are defined according to the slave line pulse received from the main control unit 20 and the slave frame pulse received from an adjustment unit 42.

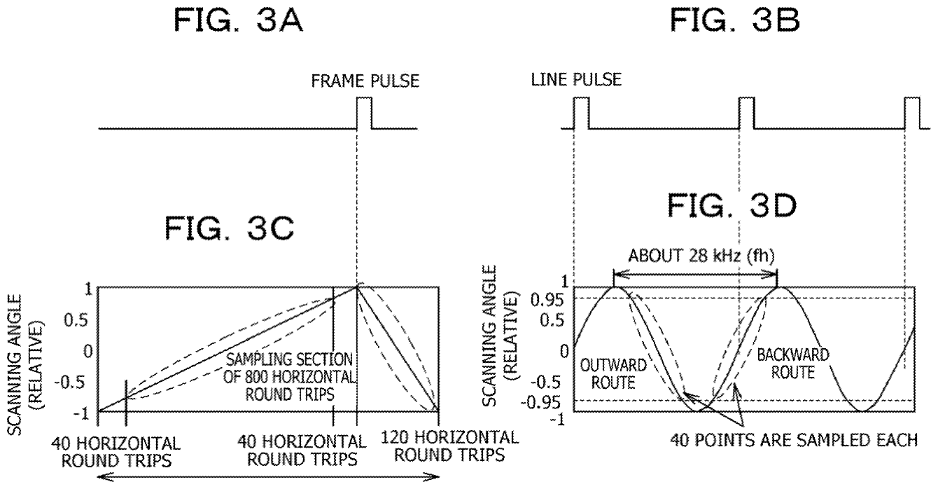

The MEMS mirror 12 scans the inside of a scanning range with the reflected light from the light emitting device 11 by driving on the two axes, namely, the vertical axis and the horizontal axis. FIG. 3A is a diagram illustrating the slave frame pulse (vertical drive timing signal) output by the main control unit 20. The frame pulse is a signal output by the MEMS mirror 12 at a scanning start timing for the scanning range. Therefore, the frame pulse is output every time the MEMS mirror 12 scans the scanning range once.

FIG. 3B is a diagram illustrating the slave line pulse (horizontal drive timing signal) output by the main control unit 20. The line pulse is a signal output by the MEMS mirror 12 at a scanning start timing for each line in the scanning range. Therefore, the line pulse is output every time the MEMS mirror 12 scans each line once. In the present embodiment, the scanning range contains 1000 lines. Therefore, the line pulse is output 1000 times in one cycle of the frame pulse.

FIG. 3C is a diagram illustrating a vertical drive signal generated by the drive signal generation unit 70 according to the timing of the frame pulse. In FIG. 3C, the lateral axis represents time, and the longitudinal axis represents a relative scanning angle in the vertical direction. The label “−1” on the longitudinal axis represents the smallest scanning angle in the vertical direction. The label “1” on the longitudinal axis represents the largest scanning angle in the vertical direction. When this relative scanning angle in the vertical direction makes a round trip between “−1” and “1”, the scanning angle in the vertical direction makes a round trip once. Each angle obtained by dividing the relative scanning angle in the vertical direction into 1000 corresponds to each line.

One round trip of the scanning angle in the vertical direction is completed from the timing of the frame pulse illustrated in FIG. 3A to the timing of the subsequent frame pulse. In the present embodiment, as an example, the scanning angle in the vertical direction changes linearly from “−1” to “1” while the round trip in a horizontal direction is performed 880 times. Thereafter, the scanning angle in the vertical direction changes linearly from “1” to “−1” while the round trip in the horizontal direction is performed 120 times. In this manner, while the round trip in the horizontal direction is performed 1000 times, the round trip in the vertical direction is performed once. The frequency at which the round trip in the vertical direction is repeated is about 28 Hz, and the frequency at which the round trip in the horizontal direction is repeated is about 28 kHz.

FIG. 3D is a diagram illustrating a horizontal drive signal generated by the drive signal generation unit 70 according to the timing of the line pulse. In FIG. 3D, the lateral axis represents time, and the longitudinal axis represents a relative scanning angle in the horizontal direction. The label “−1” on the longitudinal axis represents the smallest scanning angle in the horizontal direction. The label “1” on the longitudinal axis represents the largest scanning angle in the horizontal direction. When this relative scanning angle in the horizontal direction makes a round trip between “−1” and “1”, the scanning angle in the horizontal direction makes a round trip once. The horizontal drive signal forms a sine wave.

One round trip of the scanning angle in the horizontal direction is completed from the timing of the line pulse illustrated in FIG. 3B to the timing of the subsequent line pulse. In the present embodiment, as an example, 40 points are sampled (distance is measured) on an outward route from “0.95” to “−0.95”, and 40 points are sampled (distance is measured) on a subsequent backward route from “−0.95” to “0.95”. The sampling interval is 320 ns as an example.

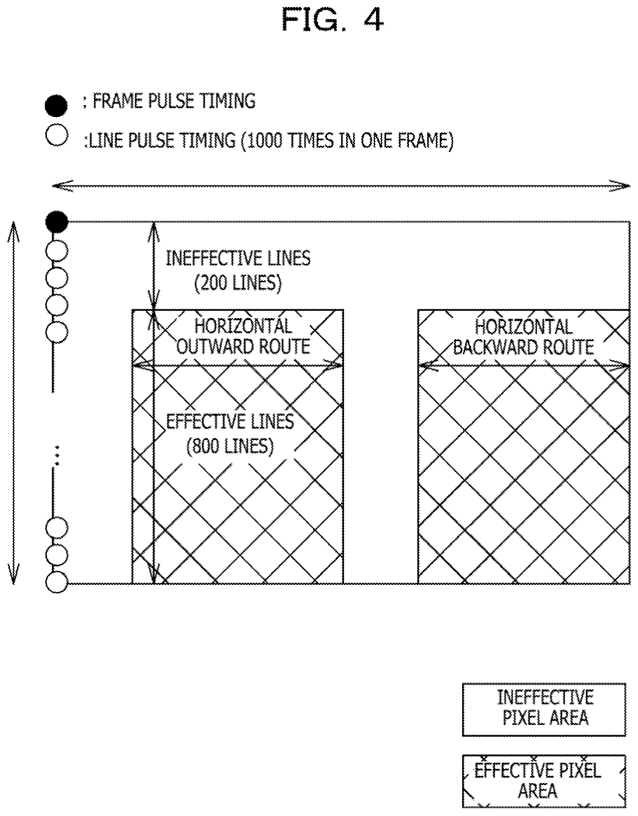

FIG. 4 is a diagram illustrating a relationship between an ineffective pixel area and an effective pixel area during such one round trip in the vertical direction. The example in FIG. 4 represents raster scanning specifications. The effective pixel area is an area where sampling is performed. The ineffective pixel area is an area where sampling is not performed. Therefore, the light emitting device 11 does not emit light in the ineffective pixel area. As illustrated in FIG. 4, 200 lines are given as ineffective lines and 800 lines are given as effective lines. Furthermore, a part of a horizontal outward route is given as an effective pixel area, and a part of a horizontal backward route is given as an effective pixel area.

Each line pulse is generated in correspondence to each pulse of the reference clock signal. Therefore, the line pulse is generated and the scanning angle in the horizontal direction makes a round trip once in the cycle of the reference clock signal. The frame pulse is generated and the scanning angle in the vertical direction makes a round trip once in a cycle of 1000 pulses of the reference clock signal.

The MEMS mirror 12 normally utilizes resonance for at least one axis among the two axes, namely, the horizontal axis and the vertical axis, in order to increase the scanning speed and also to increase the drive angle. In the present embodiment, as an example, resonance is utilized normally in the horizontal direction where the number of round trips is larger. An individual difference sometimes occurs in the resonance frequency due to variations during manufacturing. Therefore, for example, when raster scanning is performed horizontally with resonance and vertically without resonance, there is a possibility that the scanning speed in the horizontal direction differs and the frame rate differs for each individual. When two MEMS mirrors 12 having significantly different resonance frequencies in the horizontal direction are synchronized, not only the swing angle in the horizontal direction may not be sufficiently obtained, but also there is a possibility of resulting in destroying the two MEMS mirrors 12. Meanwhile, it is difficult to prepare a certain number of MEMS mirrors 12 having resonance frequencies close to each other, in terms of manufacturing accuracy.

Thus, the present embodiment has a configuration in which a deviation between resonance points due to individual differences of the MEMS mirrors 12 is corrected between a plurality of laser sensors, and the MEMS mirrors are synchronized between the plurality of laser sensors.

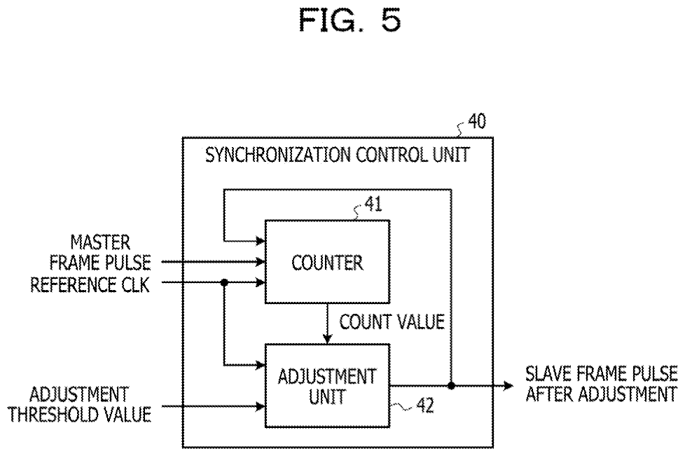

FIG. 5 is a block diagram illustrating details of the synchronization control unit 40. As illustrated in FIG. 5, the synchronization control unit 40 includes a counter 41 and the adjustment unit 42. The counter 41 receives the master frame pulse and the reference clock signal of the laser sensor 100a. The adjustment unit 42 receives the reference clock signal and the adjustment threshold value.

The counter 41 counts the pulses of the reference clock signal. In the initial setting, the minimum value of the count value is zero and the maximum value of the count value (counter value) is 999. In this manner, the counter 41 counts a number of pulses equal to the counter value of the reference clock signal. When reaching the counter value, the count value subsequently returns to zero again. Therefore, the count value is supposed to take values from zero to the counter value. The counter 41 sends the count value at the time point of receiving the master frame pulse from the laser sensor 100a, which is the reference device, to the adjustment unit 42. Note that the laser sensor 100a, which is the reference device, outputs the master frame pulse with 1000 pulses of the reference clock signal as one cycle. For example, it is assumed that both the laser sensors 100a and 100b output the frame pulse at the timing when the count value is zero. If the laser sensors 100a and 100b are synchronized, the count value of the laser sensor 100b also becomes zero at the timing when the count value of the laser sensor 100a becomes zero. However, if the laser sensors 100a and 100b are not synchronized, a difference will occur between the count value of the laser sensor 100a and the count value of the laser sensor 100b.

The adjustment unit 42 calculates a phase advance/delay amount between the laser sensors 100a and 100b from the count value received from the counter 41. For example, in the laser sensor 100a, the master frame pulse is output at the timing when the count value is zero, and accordingly, if the count value received by the adjustment unit 42 is other than zero, it is deemed that a phase difference has occurred. Thus, the adjustment unit 42 adjusts the counter value according to the calculated phase advance/delay amount. The updated counter value is fed back to the counter 41 and reused for comparison with the master frame pulse (the frame pulse of the laser sensor 100a) next time.

The adjustment unit 42 adjusts the frame pulse received from the main control unit 20, using the adjusted counter value and the reference clock signal. For example, the frame pulse is made to be output at the timing when the count value becomes zero when the counter 41 performs counting using the counter value after adjustment.

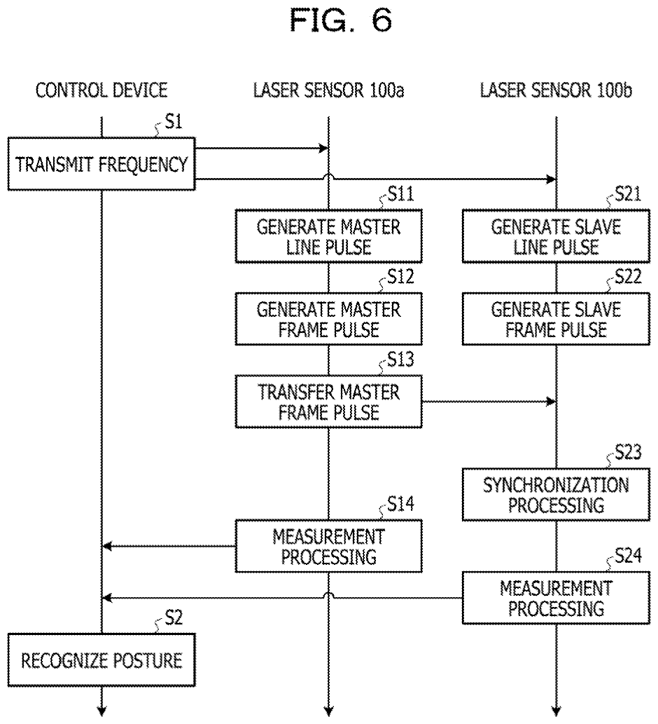

FIG. 6 is a flowchart representing an example of the operation of the posture recognition system 300. As illustrated in FIG. 6, the control device 200 transmits the frequency to the laser sensors 100a and 100b (step S1).

The main control unit 20 of the laser sensor 100a uses the reference clock signal at the frequency received from the control device 200 to generate the master line pulse (step S11) and to generate the master frame pulse (step S12). The main control unit 20 of the laser sensor 100a transfers the master frame pulse to the laser sensor 100b (step S13). Thereafter, in the laser sensor 100a, the laser light emitting unit 60 emits pulsed light in the sampling cycle, and the drive signal generation unit 70 generates a drive signal according to the master frame pulse and the master line pulse to control the MEMS mirror 12. This means that, in the laser sensor 100a, the synchronization control unit 40 does not perform synchronization control. In the laser sensor 100a, the flight time measurement unit 80 measures the distance in the sampling cycle (step S14). The result of the distance measurement is sent to the control device 200.

The main control unit 20 of the laser sensor 100b uses the reference clock signal at the frequency received from the control device 200 to generate the slave line pulse (step S21) and to generate the slave frame pulse (step S22). Next, the synchronization control unit 40 performs synchronization processing (step S23). Consequently, the slave frame pulse is adjusted.

Thereafter, in the laser sensor 100b, the laser light emitting unit 60 emits pulsed light in the sampling cycle, and the drive signal generation unit 70 generates a drive signal according to the slave frame pulse and the slave line pulse to control the MEMS mirror 12. The flight time measurement unit 80 measures the distance in the sampling cycle (step S24). The result of the distance measurement is sent to the control device 200.

The control device 200 recognizes the posture of the distance measurement target by reproducing the three-dimensional shape of the distance measurement target, using the result of the distance measurement in step S14 and the result of the distance measurement in step S24 (step S2).

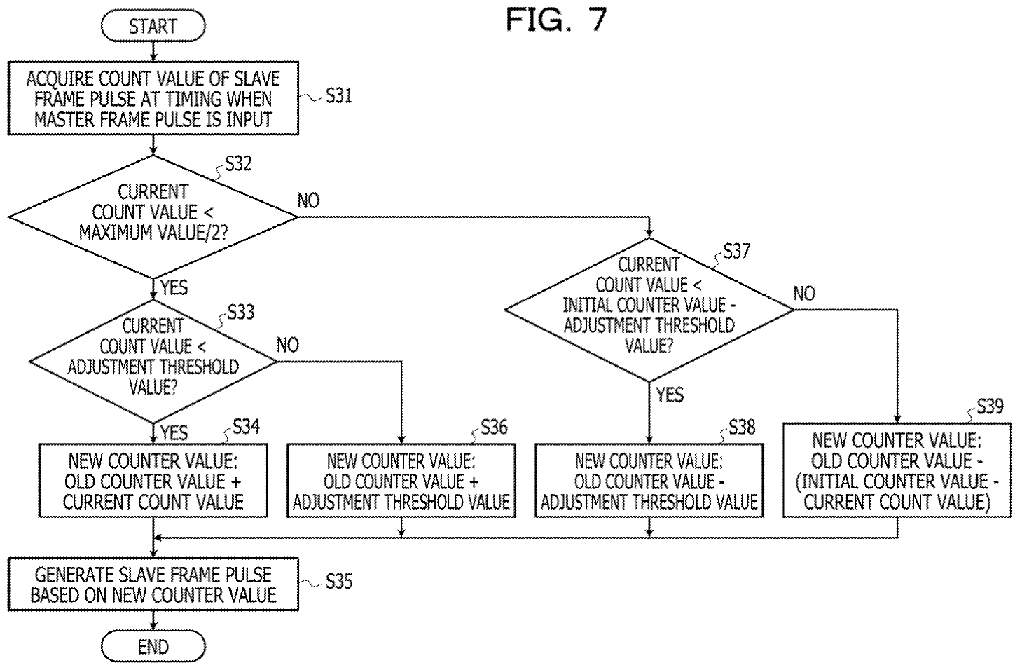

FIG. 7 is a flowchart representing an example of synchronization control in step S23. As illustrated in FIG. 7, the counter 41 of the laser sensor 100b acquires the count value of the slave frame pulse of the laser sensor 100b at the timing when the master frame pulse from the laser sensor 100a is input (step S31). The acquired count value is sent to the adjustment unit 42 as a current count value.

Next, the adjustment unit 42 determines whether or not the current count value is less than half of the maximum value (the initial value is 999) (step S32). If the count value is zero, it is deemed that the laser sensors 100a and 100b are synchronized. If 0<count value<half of the maximum value holds, it is deemed that the timing of the frame pulse of the laser sensor 100b is ahead of the timing of the frame pulse of the laser sensor 100a.

When “Yes” is determined in step S32, the adjustment unit 42 determines whether or not the current count value is less than the adjustment threshold value (step S33). If the current count value is less than the adjustment threshold value, it is deemed that the frame pulse of the laser sensor 100b has a small amount of advancement from the frame pulse of the laser sensor 100a. If the current count value is equal to or greater than the adjustment threshold value, it is deemed that the frame pulse of the laser sensor 100b has a large amount of advancement from the frame pulse of the laser sensor 100a.

When “Yes” is determined in step S33, the adjustment unit 42 assigns the sum of an old counter value and the current count value as a new counter value (step S34). The old counter value refers to a counter value when the flowchart in FIG. 7 was executed last time. At the first execution of the flowchart in FIG. 7, the old counter value refers to the initial counter value and is set to 999. By increasing the counter value, a timing at which the count value of the counter 41 returns to zero is delayed, and as a result, a timing at which the slave frame pulse is generated will be delayed. Consequently, a difference between the timing of the frame pulse of the laser sensor 100b and the timing of the frame pulse of the laser sensor 100a becomes smaller.

Next, the adjustment unit 42 generates the slave frame pulse based on the new counter value (step S35). Thereafter, the execution of the flowchart ends.

When “No” is determined in step S33, the adjustment unit 42 assigns the sum of the old counter value and the adjustment threshold value as a new counter value (step S36). Thereafter, step S35 is executed.

When “No” is determined in step S32, the adjustment unit 42 determines whether or not the current count value is less than (the initial counter value−the adjustment threshold value) (step S37). If the current count value is less than (the initial counter value−the adjustment threshold value), it is deemed that the frame pulse of the laser sensor 100b has a small amount of delay from the frame pulse of the laser sensor 100a. If the current count value is equal to or greater than (the initial counter value−the adjustment threshold value), it is deemed that the frame pulse of the laser sensor 100b has a large amount of delay from the frame pulse of the laser sensor 100a.

When “Yes” is determined in step S37, the adjustment unit 42 assigns a value obtained by subtracting the adjustment threshold value from the old counter value, as a new counter value (step S38). Thereafter, step S35 is executed.

When “No” is determined in step S37, the adjustment unit 42 assigns a value obtained by subtracting (the value obtained by subtracting the current count value from the initial counter value) from the old counter value, as a new counter value (step S39). Thereafter, step S35 is executed.

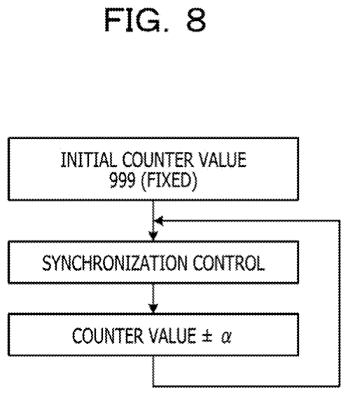

FIG. 8 is a diagram representing fluctuations in the counter value when the synchronization control in FIG. 7 is repeated. First, the initial counter value is set to 999. When the synchronization control in FIG. 7 is performed, the counter value is adjusted. When the synchronization control is repeated, the counter value is adjusted each time.

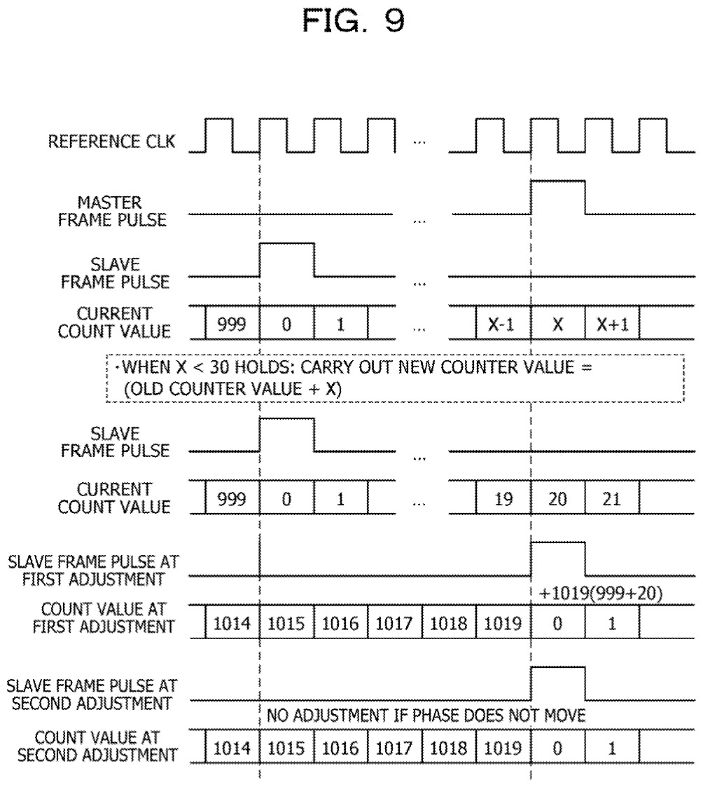

FIG. 9 is a diagram illustrating details of steps S32 to S35. The old counter value is assumed as the initial counter value (999), and the adjustment threshold value is assumed as 30. If a current count value X is less than 500, it is verified that the slave frame pulse of the laser sensor 100b is ahead of the master frame pulse of the laser sensor 100a. If the current count value X is less than the adjustment threshold value, the sum of the old counter value and the current count value X is assigned as a new counter value, as illustrated in FIG. 9. For example, since the old counter value is the initial counter value (999) and the current count value is 20, the new counter value is given as 1019. In this case, the slave frame pulse will not be output until the count rises to 1019, and a timing at which the slave frame pulse is output may be delayed.

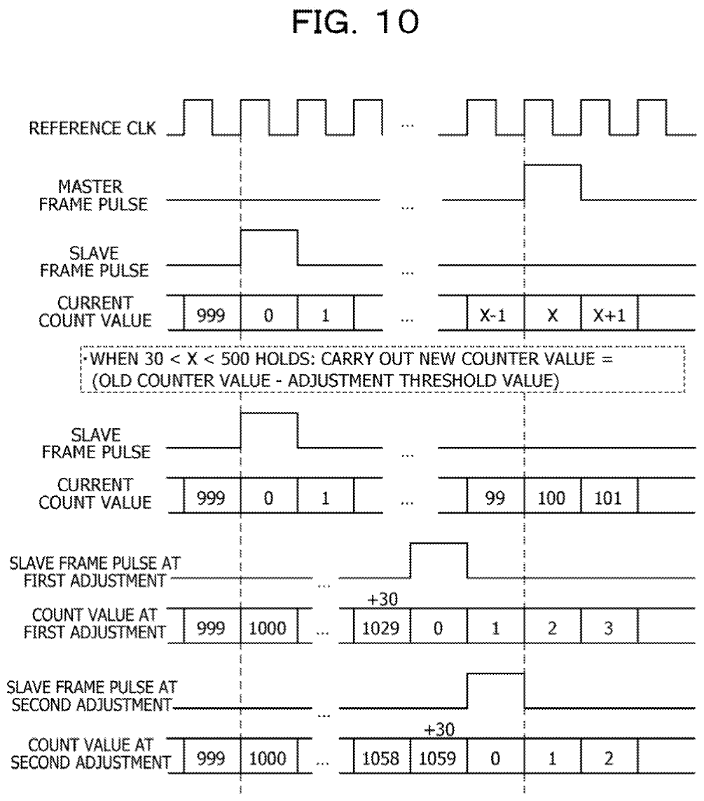

FIG. 10 is a diagram illustrating details of step S32>step S33>step S36>step S35. The old counter value is assumed as the initial counter value (999), and the adjustment threshold value is assumed as 30. If the current count value X is less than 500, it is verified that the slave frame pulse of the laser sensor 100b is ahead of the master frame pulse of the laser sensor 100a. In this case, if the current count value X is equal to or greater than the adjustment threshold value, the sum of the old counter value and the adjustment threshold value is assigned as a new counter value, as illustrated in FIG. 10. For example, since the old counter value is the initial counter value (999) and the adjustment threshold value is 30, the new counter value is given as 1029. In this case, the slave frame pulse will not be output until the count rises to 1029, and a timing at which the slave frame pulse is output may be delayed.

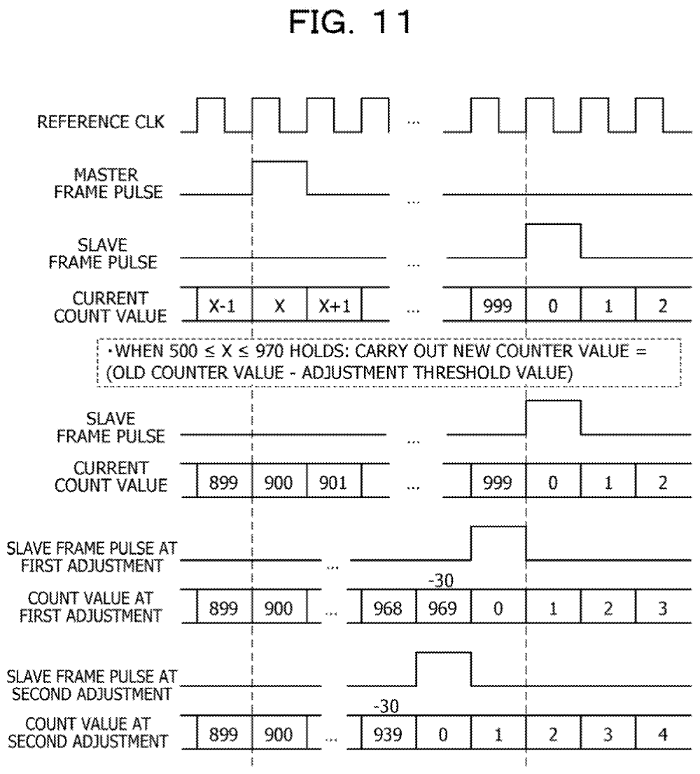

FIG. 11 is a diagram illustrating details of step S32>step S37>step S38>step S35. The old counter value is assumed as the initial counter value (999), and the adjustment threshold value is assumed as 30. If the current count value X is equal to or greater than 500, it is verified that the slave frame pulse of the laser sensor 100b is behind the master frame pulse of the laser sensor 100a. If the current count value X is less than (the old counter value−the adjustment threshold value), the value obtained by subtracting the adjustment threshold value from the old counter value is assigned as a new counter value, as illustrated in FIG. 11. For example, since the old counter value is the initial counter value (999) and the current count value is 19, the new counter value is given as 980. In this case, since the slave frame pulse will be output when the count rises to 980, a timing at which the slave frame pulse is output may be brought forward.

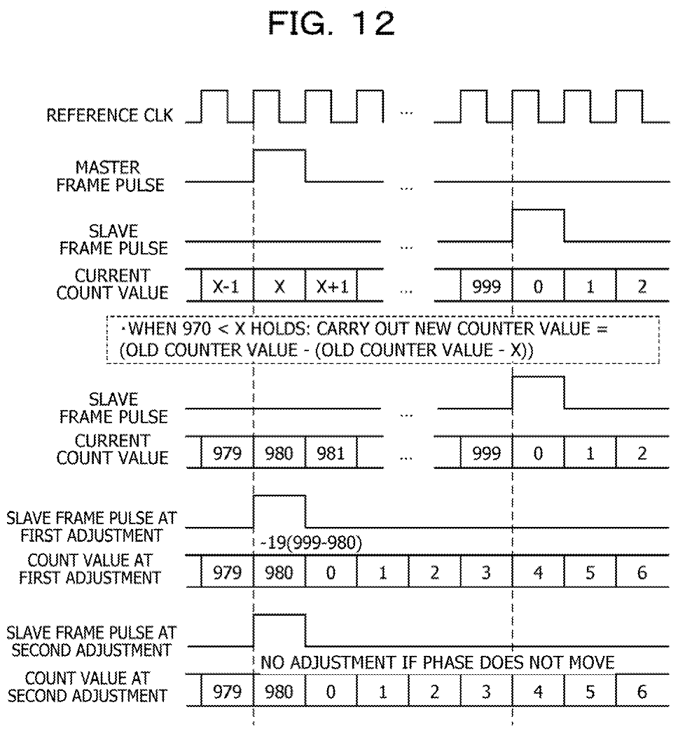

FIG. 12 is a diagram illustrating details of step S32>step S37>step S39>step S35. The old counter value is assumed as the initial counter value (999), and the adjustment threshold value is assumed as 30. If the current count value X is equal to or greater than 500, it is verified that the slave frame pulse of the laser sensor 100b is behind the master frame pulse of the laser sensor 100a. In this case, if the current count value X is equal to or greater than (the old counter value−the adjustment threshold value), a value obtained by subtracting (the value obtained by subtracting the current count value from the old counter value) from the old counter value is assigned as a new counter value, as illustrated in FIG. 12. For example, since the old counter value is the initial counter value (999) and the adjustment threshold value is 30, the new counter value is given as 969. In this case, the slave frame pulse will be output when the count rises to 969, and a timing at which the slave frame pulse is output may be brought forward.

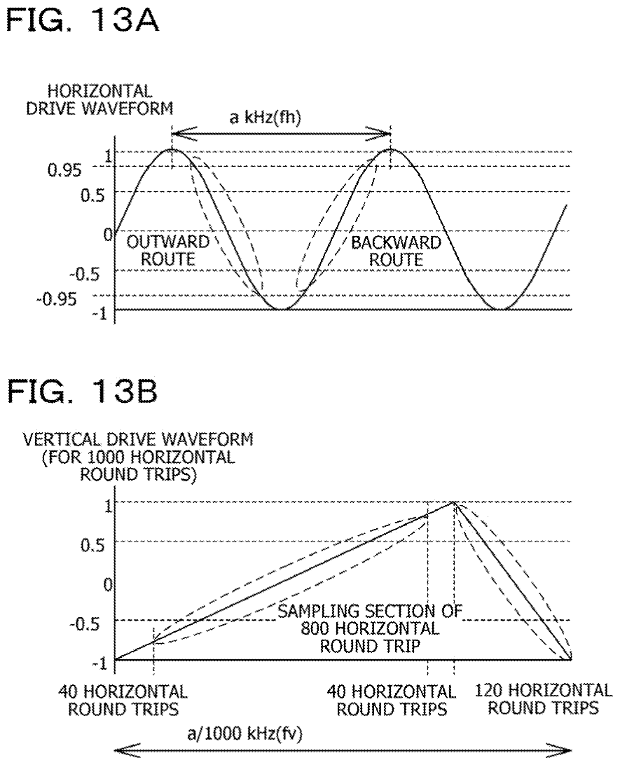

FIGS. 13A and 13B are diagrams illustrating drive cycles of the laser sensor 100a, which is the reference device. FIG. 13A is a diagram illustrating the horizontal drive signal generated by the drive signal generation unit 70 according to the timing of the line pulse. FIG. 13B is a diagram illustrating the vertical drive signal generated by the drive signal generation unit 70 according to the timing of the frame pulse. As illustrated in FIG. 13A, it is assumed that the horizontal drive signal has a frequency of a kHz. In this case, as illustrated in FIG. 13B, the frequency of the vertical drive signal is given as a/1000 kHz.

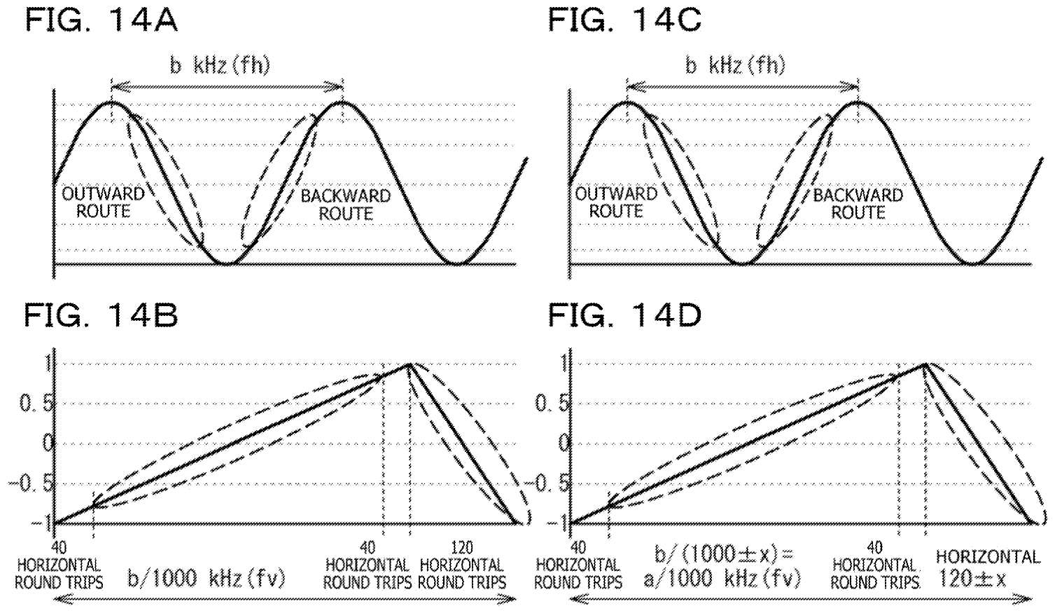

FIGS. 14A and 14B are diagrams illustrating drive cycles of the laser sensor 100b, which is the adjustment target device. FIG. 14A is a diagram illustrating the horizontal drive signal generated by the drive signal generation unit 70 according to the timing of the line pulse. FIG. 14B is a diagram illustrating the vertical drive signal generated by the drive signal generation unit 70 according to the timing of the frame pulse. As illustrated in FIG. 14A, it is assumed that the horizontal drive signal has a frequency of b kHz. In this case, as illustrated in FIG. 14B, the frequency of the vertical drive signal is given as b/1000 kHz.

In the present embodiment, when a≠b holds, the non-resonant drive cycle of the MEMS mirror 12 of the laser sensor 100b will be synchronized with the non-resonant drive cycle of the MEMS mirror 12 of the laser sensor 100a. At the time of synchronization, the current count value X, which is the count value in the drive cycle of the horizontal drive signal, is used. Therefore, as illustrated in FIG. 14D, the frequency of the vertical drive signal of the MEMS mirror 12 of the laser sensor 100b is made to coincide with the frequency of the vertical drive signal of the MEMS mirror 12 of the laser sensor 100a.

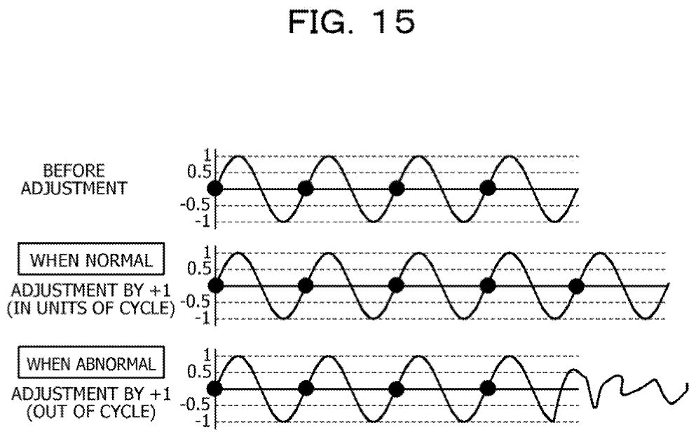

FIG. 15 is a diagram for explaining the horizontal drive signal when being subject to synchronization control. The upper part of FIG. 15 is a diagram illustrating a horizontal drive signal before being subjected to synchronization control. The middle part of FIG. 15 is a diagram illustrating a horizontal drive signal after being subjected to synchronization control in line with the drive cycle of the horizontal drive signal. If synchronization control is conducted in line with the drive cycle of the horizontal drive signal, the horizontal drive signal becomes stable. In contrast to this, the lower part of FIG. 15 is a diagram illustrating a horizontal drive signal after being subjected to synchronization control out of the drive cycle of the horizontal drive signal. When synchronization control is conducted out of the drive cycle of the horizontal drive signal, the horizontal drive signal tends to become abnormal and the MEMS mirror 12 becomes unstable. Furthermore, it takes a long time for the operation of the MEMS mirror 12 to return to stable operation.

As described above, according to the present embodiment, control is performed to synchronize the drive cycle of the MEMS mirror 12 of the laser sensor 100b in the non-resonant direction with the drive cycle of the MEMS mirror 12 of the laser sensor 100a in the non-resonant direction, using a timing designated based on the drive cycle in the resonance direction. According to this configuration, even if there are individual differences in the resonance frequency between a plurality of the MEMS mirrors 12, the MEMS mirrors 12 may be synchronized while damage and unstable operation of the MEMS mirrors 12 are suppressed.

Furthermore, according to the present embodiment, synchronization control is performed on the laser sensor 100b at a timing in the ineffective pixel area of the laser sensor 100a. For example, synchronization control is performed on the laser sensor 100b at a timing when the laser sensor 100a is not emitting light. Therefore, it may be possible to suppress light interference between the laser sensors 100a and 100b.

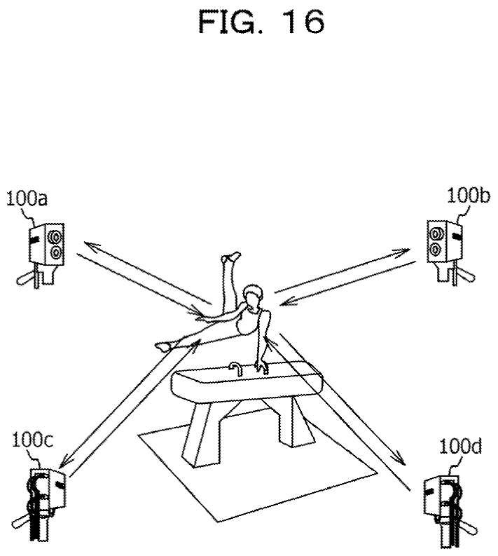

FIG. 16 is a diagram illustrating an application example of the posture recognition system 300. As illustrated in FIG. 16, a plurality of laser sensors 100a to 100d is installed. These laser sensors 100a to 100d are installed so as to surround a posture recognition target (a gymnastics athlete in the example in FIG. 16). There is a possibility that some parts of the athlete's own body or equipment causes shadows, which produce a portion of the athlete's body for which 3D data may not be acquired. Thus, the laser sensors 100a to 100d are installed so as to sandwich the athlete from the front and back of the athlete. This allows the measurement of detailed 3D data (posture) of the athlete. By facing each other in this manner, it becomes easier for the interference to come about. Accordingly, the interference may be avoided using the synchronization technique as in the above embodiment.

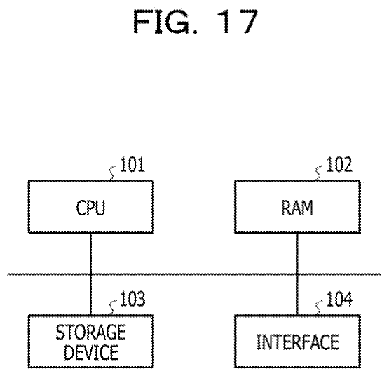

FIG. 17 is a block diagram for explaining hardware configurations of the main control unit 20, the reference clock generation unit 30, the synchronization control unit 40, the light emission signal generation unit 50, the laser light emitting unit 60, the drive signal generation unit 70, and the flight time measurement unit 80. As illustrated in FIG. 17, each of these units is implemented by a central processing unit (CPU) 101, a random access memory (RAM) 102, a storage device 103, an interface 104, and the like. These components are respectively connected to one another by a bus or the like. The CPU 101 is a central processing unit. The CPU 101 includes one or more cores. The random access memory (RAM) 102 is a volatile memory that temporarily stores a program to be executed by the CPU 101, data to be processed by the CPU 101, and the like. The storage device 103 is a nonvolatile storage device. For example, a read only memory (ROM), a solid state drive (SSD) such as a flash memory, a hard disk to be driven by a hard disk drive, or the like may be used as the storage device 103. When the CPU 101 executes a program stored in the storage device 103, the main control unit 20, the reference clock generation unit 30, the synchronization control unit 40, the light emission signal generation unit 50, the laser light emitting unit 60, the drive signal generation unit 70, and the flight time measurement unit 80 are implemented. Note that the main control unit 20, the reference clock generation unit 30, the synchronization control unit 40, the light emission signal generation unit 50, the laser light emitting unit 60, the drive signal generation unit 70, and the flight time measurement unit 80 may be implemented by an integrated circuit such as an application specific integrated circuit (ASIC) or a field programmable gate array (FPGA). For example, the synchronization control unit 40, the light emission signal generation unit 50, and the drive signal generation unit 70 may be implemented by the FPGA. Alternatively, the main control unit 20, the reference clock generation unit 30, the synchronization control unit 40, the light emission signal generation unit 50, the laser light emitting unit 60, the drive signal generation unit 70, and the flight time measurement unit 80 may be dedicated circuits or the like.

In each of the above examples, the MEMS mirror 12 is an example of a MEMS mirror that performs scanning in a reflection direction of laser light of the light emitting device on the first axis in the resonance direction and the second axis in the non-resonant direction. The synchronization control unit 40 is an example of a synchronization control unit that performs control that synchronizes the drive cycle of the second axis with the drive cycle of the second axis of the MEMS mirror mounted on another laser sensor, using a timing designated based on the drive cycle of the first axis. The laser sensor 100a is an example of a first laser sensor, and the laser sensor 100b is an example of a second laser sensor. The control device 200 is an example of a recognition unit that recognizes the posture of a distance measurement target, using sensing results of the first laser sensor and the second laser sensor.

While the embodiments have been described above in detail, the embodiments are not limited to such specific embodiments, and various modifications and alterations may be made within the scope of the embodiments described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

what is claimed is:

1. A laser sensor comprising:
a micro electro mechanical systems (MEMS) mirror that performs scanning in a reflection direction of laser light of a light emitting device on a first axis in a resonance direction and a second axis in a non-resonant direction; and
a processor that performs control that synchronizes a drive cycle of the second axis with the drive cycle of the second axis of the MEMS mirror mounted on another laser sensor, using a timing designated based on the drive cycle of the first axis.

2. The laser sensor according to claim 1, wherein the drive cycle of the first axis is designated according to a pulse cycle of a clock signal, and
the processor adjusts the drive cycle of the second axis in units of the pulse cycle of the clock signal.

3. The laser sensor according to claim 1, wherein the processor designates an adjustment amount for the drive cycle of the second axis, according to a difference amount between a phase of the drive cycle of the second axis and the phase of the drive cycle of the second axis of the MEMS mirror mounted on the another laser sensor.

4. The laser sensor according to claim 1, wherein the processor performs the control that synchronizes the drive cycle of the second axis with the drive cycle of the second axis of the MEMS mirror mounted on the another laser sensor, when the light emitting device of the another laser sensor is not emitting light.

5. A mirror control method comprising:
performing, by a micro electro mechanical systems (MEMS) mirror, scanning in a reflection direction of laser light of a light emitting device on a first axis in a resonance direction and a second axis in a non-resonant direction; and
performing, by a processor, control that synchronizes a drive cycle of the second axis with the drive cycle of the second axis of the MEMS mirror mounted on another laser sensor, using a timing designated based on the drive cycle of the first axis.

6. A posture recognition system comprising:
a first laser sensor and a second laser sensor each including a micro electro mechanical systems (MEMS) mirror configured to perform scanning in a reflection direction of laser light of a light emitting device on a first axis in a resonance direction and a second axis in a non-resonant direction; and
a processor configured to recognize the posture of a distance measurement target, using sensing results of the first laser sensor and the second laser sensor,
wherein the second laser sensor is configured to perform control that synchronizes a drive cycle of the second axis with the drive cycle of the second axis of the MEMS mirror mounted on another laser sensor, using a timing designated based on the drive cycle of the first axis.
